(19) United States
(12) Patent Application Publication
(10) Pub. No.: US 2006/0191370 A1
(43) Pub. Date: Aug. 31, 2006

(54) Compressor crankshaft

(75) Inventors: Marten Nommensen, Flensburg (DE); Frank Holm Iversen, Padborg (DK); Heinz Otto Lassen, Flensburg (DE); Christian Petersen, Hattstedt (DE); Beate Sonksen, Hattstedt (DE)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 11/269,943

(22) Filed: Nov. 8, 2005

(30) Foreign Application Priority Data
Nov. 10, 2004 (DE) 10 2004 054 186.8

(51) Int. Cl. F16C 3/04

(52) U.S. Cl. 74/595

(57) ABSTRACT

The invention concerns a compressor crankshaft (1), particularly a refrigerant compressor crankshaft, with a hollow shaft element (2), a crank pin (3) arranged eccentrically to the shaft element (2) and a transition element (4) between the shaft element (2) and the crank pin (3). It is endeavoured to reduce the manufacturing costs.

For this purpose, the shaft element (2) has at least two shaft sections (5, 6) joined in a telescope-like manner, which engage in each other in an overlapping area (7).

The invention concerns a compressor crankshaft, particularly a refrigerant compressor crankshaft, with a hollow shaft element, a crank pin arranged eccentrically to the shaft element and a transition element between the shaft element and the crank pin.

Refrigerant compressors, which are made as plunger piston compressors, usually have a crankshaft, whose shaft element is unrotatably connected with the rotor of a drive motor. The drive shaft again is connected with a crank pin, which converts the rotary movement of the crank shaft to a reciprocating movement. For this purpose, the crank pin is connected with the piston of the plunger piston compressor via a connecting rod.

Usually, such crankshafts are forged or cast. They can be assembled of several elements.

Such a crankshaft assembled of several elements is, for example, known from U.S. Pat. No. 5,237,892 A or U.S. Pat. No. 4,493,226 A.

Also known are crankshafts, in which the piston element, the crank pin and the transition element are made in one piece, see, for example, U.S. Pat. No. 6,095,768.

Refrigerant compressors are usually manufactured in bulk. However, normally different kinds of refrigerant compressors are required, which, for example, differ in output. The output to be supplied by the refrigerant compressor has to be provided by the drive motor. Accordingly, the drive motors often differ in their output and thus in their axial extension. This means that also an accordingly large number of different crankshafts is required. This increases the costs of stocks and manufacturing.

The invention is based on the task of reducing the manufacturing costs.

With a crankshaft as mentioned in the introduction, this task is solved in that the shaft element has at least two shaft sections joined in a telescope-like manner, which engage in each other in an overlapping area.

This embodiment has substantial advantages. For compressors with different refrigeration capacities requiring different drive motor sizes the same shaft components can be used. The length of the overlapping area determines the desired total length of the crankshaft. Thus, when the overlapping area is long, the crankshaft is short. When the overlapping area is short, the total length of the crankshaft is correspondingly longer. This is a simple manner of adapting the length of the crankshaft to the motor size, that is, the height of the stator core lamination, without having to use different components. This saves costs in manufacturing and stocks.

Preferably, a bearing area is located on the circumference of at least two shaft sections. This increases the stability of the bearing, so that, for example, an air gap between the rotor and the stator of the drive motor can be set with a relatively high accuracy. This increases the efficiency. With this embodiment, the load on the connection between the two shaft sections in the overlapping area is only relatively small or non-existent.

Preferably, the shaft sections comprising the bearing area are formed near the ends of the shaft element. Thus, the shaft element is supported in the area of its two ends.

Preferably, a rotor of a drive motor overlaps the overlapping area at least partly and is unrotatably fixed on the shaft element. The rotor provides an additional stabilisation of the overlapping area, thus ensuring an increased mechanical loadability of the crankshaft.

Preferably, each shaft section is made as a deep-drawn part. Thus, each shaft section can be formed of even sheet steel by means of a deep-drawing process. Compared with the use of welded pipes, the costs of manufacturing are lower. However, the length of pipes drawn from even sheet steel is limited. For this reason it has until now been practically impossible to manufacture the complete shaft element of a crankshaft by means of deep-drawing. This restriction is now overcome in that several shaft sections are used. By means of the deep-drawing, it is further possible to make shaft sections with relatively small tolerances, so that the individual shaft sections fit well into each other and can be connected with each other in the overlapping area.

Preferably, a first shaft section remote from the crank pin is inserted in a second shaft section adjacent to the crank pin. Usually, a refrigerant compressor is arranged so that with a vertical alignment of the crank shaft, the crank pin is located at the upper end. The crankshaft is also inserted in the rotor from the upper end. When now the first shaft section, that is, the lower shaft section, is inserted in the second shaft section, that is, the upper shaft section, this involves two advantages. Firstly, due to its smaller diameter, the lower shaft section is more easily led through the rotor without risking that its bearing area is damaged. Secondly, it ensures a better effect of the oil pump, which is formed by the shaft element. Inside the hollow shaft element a diameter increase occurs, which further improves the oil supply in connection with a corresponding centrifugal force.

Preferably, in the overlapping area, the second shaft section has a diameter increase, which forms a unilaterally open pocket. With a vertical alignment of the crankshaft, this pocket is open upwards. This pocket has the advantage that, when shutting down the compressor, a certain oil supply is already available at half height, so to speak. This oil supply has the effect that the oil from here will sooner reach the positions to be lubricated than oil from an oil sump at the lower end of the shaft element. This improves the lubrication.

Preferably, the first shaft section has a tapering at the end of the shaft element, a blade being located to be adjacent to the tapering in the inner chamber of the first shaft section. The tapering forms the beginning of a centrifugal pump. The blade causes that the oil, in which the shaft element is immersed, is more easily taken along, so that the acceleration in the circumferential direction of the oil amount penetrating into the hollow interior of the shaft element is improved.

Preferably, the shaft sections are connected with each other without the use of joining elements. In the simplest case, they can be connected by means of force fit. However, they can also be connected by gluing, soldering or welding. In many cases, a spot-welding will be sufficient.

Preferably, the transition element has a pin projecting into the shaft element. The first task of the pin is to fix the transition element on the shaft element. Secondly, the pin stabilises the crankshaft as a whole.

This is particularly the case, when the pin extends over at least the length of a bearing area. Thus, preferably, the pin extends over the length of the crank pin-side bearing and stabilises the crankshaft here. This causes that the forces transmitted from a connecting rod to the crank pin can be adopted without causing a distortion of the crankshaft, also when the crankshaft is dimensioned to be relatively weak.

Preferably, the pin has at least one axial channel, which is connected with the inside of the shaft element. In spite of the pin, this axial channel permits oil to flow from the hollow inner chamber of the shaft element to positions above the pin, which have to be lubricated.

Preferably, the transition element has a bearing surface surrounding the pin, the shaft element ending at a predetermined distance from the bearing surface. Thus, the transition element forms a part of an axial bearing. The fact that the shaft element ends at a predetermined distance from the bearing surface causes that a gap occurs, which can be used as circumferential channel for the lubricating oil.

Preferably, a bearing located at the crank pin end of the shaft element has a bevelling in the area of the bearing surface. This bevelling increases the free cross-section of the oil channel, so that the oil transport is improved.

In the following, the invention is described on the basis of preferred embodiments in connection with the drawings, showing:

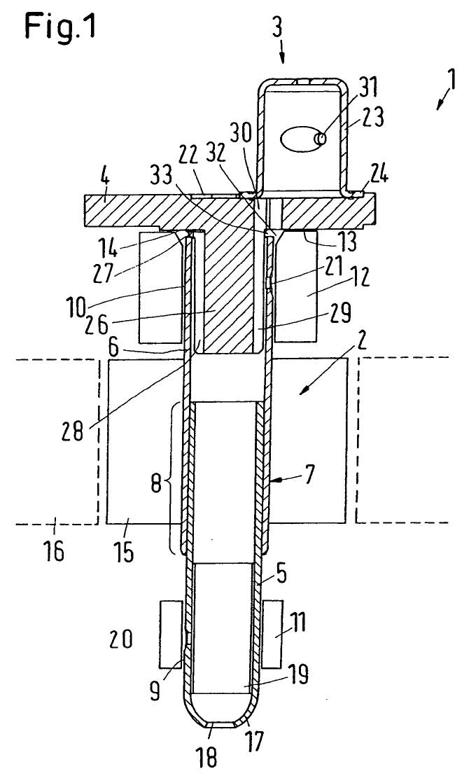

FIG. 1 a schematic sectional view of a crankshaft

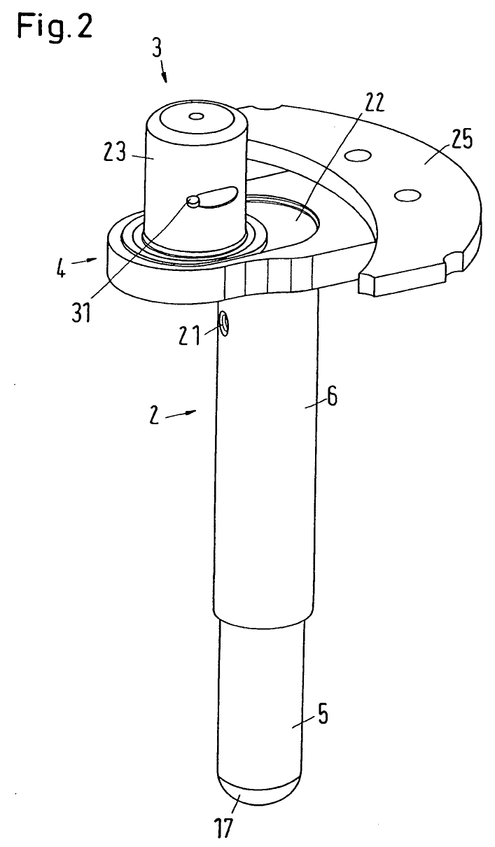

FIG. 2 the crankshaft according to FIG. 1 in a perspective view

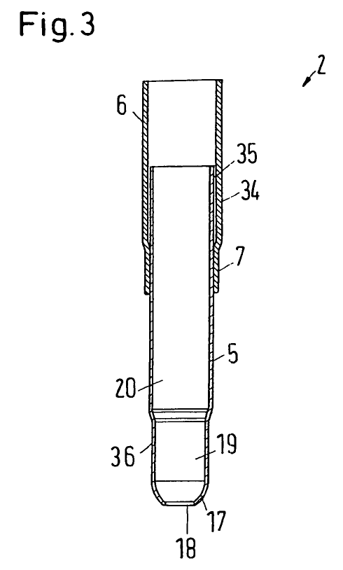

FIG. 3 a modified embodiment of a shaft element of the crankshaft.

FIG. 1 is a schematic view of a crankshaft 1 with a shaft element 2, a crank pin 3 and a transition element 4 between the shaft element 2 and the crank pin 3. The crank pin 3 is arranged eccentrically to the shaft element 2, as commonly known from crankshafts.

In the present case, the shaft element 2 has a first shaft section 5 having a larger distance to the crank pin 3 than a second shaft section 6. As, usually, the crankshaft 1 is driven in a vertical alignment, in which the crank pin 3 is located at the upper end, the first shaft section 5 is also called the lower shaft section and the second shaft section 6 is also called the upper shaft section.

The two shaft sections 5, 6 are inserted in each other in a telescope-like manner and connected with each other in an overlapping area 7. The overlapping area has a length 8. This length 8 is variable. A shortening of the overlapping area 7 will increase the axial length of the crankshaft 1. An extension of the overlapping area 7 will decrease the axial length of the crankshaft 1.

The first shaft section 5 and the second shaft section 6 are both made as deep-drawn cylindrical sheet metal pipes, that is, both shaft sections 5, 6 are made as deep-drawn parts from an even sheet steel. However, the deep-drawing process limits the possible axial length of each shaft section 5, 6. However, by using several shaft sections 5, 6; the required length of the shaft element 2 can be provided. If required, also more than the shown two shaft sections 5, 6 can be inserted in each other, thus forming several overlapping areas 7.

The lower shaft section 5 has an outer diameter, which corresponds to the inner diameter of the upper shaft section 6. With correspondingly narrow tolerances, the lower shaft section 5 can be fixed in the upper shaft section 6 in a friction-fitting manner, in that the lower shaft section 5 is pressed into the upper shaft section. Usually, however, the lower shaft section 5 will also be fixed by other measures in the upper shaft section 6, for example by gluing, soldering, welding, for example spot-welding, or shrink-fitting.

Each shaft section 5, 6 has a bearing area 9, 10. The bearing areas 9, 10 are located axially outside the overlapping area 7. Outside the overlapping area 7 the risk of a deformation of the two shaft sections 5, 6 is relatively low, so that each bearing area 9, 10 is located on a circular contour of the shaft sections 5, 6.

The lower bearing area 9 is supported in a schematically shown radial bearing 11, whereas the upper bearing area 10 is supported in an also schematically shown radial bearing 12. By a bearing surface 13, the upper radial bearing 12 forms a part of an axial bearing. The other part of the axial bearing is formed by the transition element 4, which has a bearing surface 14 on its bottom side.

A rotor 15 is pressed onto the upper shaft section 6. It overlaps the overlapping area 7, at least partly. The rotor 15 forms a part of a drive motor, whose stator 16 is merely shown schematically.

With this embodiment it can be seen, why it is advantageous to insert the lower shaft section 5 into the upper shaft section 6. Usually, the shaft element 2 is inserted into the rotor 15 from above. The reduced diameter of the lower shaft section 5 has the advantage that the bearing area 9 interacting with the lower radial bearing 11 is not damaged when pushing and pressing the rotor 15 onto the shaft element 2. Further, the reduced outer diameter of the lower shaft section 5 causes a reduction of the bearing forces occurring in the radial bearing 11 and of the surface of the radial bearing 11 and thus also of the frictional losses.

At its lower end, that is, at the end of the shaft element 2 remote from the crank pin, the lower shaft section 5 has a tapering 17, which has an approximately centrally arranged opening 18. Next to the tapering 17 is located an oil blade 19 inside the shaft element 2. With the opening 18, the tapering 17 immerses in an oil sump (not shown in detail) and forms an oil pump arrangement. The oil entering the hollow inside of the shaft element 2 from the oil sump is made rotating by the shaft blade 19, the centrifugal forces when turning the crankshaft 1 pressing the oil against and upwards along the inner wall of the crankshaft.

For lubrication of the radial bearing 11, a radial opening 20 is provided in the lower shaft section 5. A corresponding radial opening 21 is available in the area of the upper radial bearing 12. The two radial openings 20, 21 can be made during the deep-drawing process for manufacturing the two shaft sections 5, 6. Also the tapering 17 at the lower end of the lower shaft section with the opening 18 can be made during the deep-drawing. Except for a grinding, after inserting and connecting the two shaft sections 5, 6, of the bearing surfaces 9, 10 or even of the complete shaft element 2 to ensure the parallelism of shaft element 2 and crank pin 3 and, if required, a surface hardening process, no separate working is required. As thus also the oil pump arrangement (tapering 17), which is immersed in the oil sump and integrated in the crankshaft, extends concentrically with the rest of the shaft element 2, a possible wave formation, or even a foam formation, in the sump is avoided.

On its upper side, the transition element 4 has a recess 22, in which a cup 23 opening downwards is inserted, said cup forming the crank pin 3. The cup 3 has an outwardly bent flange 24, with which the cup 23 can be connected with the transition element 4 over a somewhat larger surface. This is shown more clearly in FIG. 2, in which the same elements have the same reference numbers. From FIG. 2 it also appears that the transition element 4 is provided with a counterweight 25.

A displacement of the crank pin 3 in the recess 22 will ensure setting of the eccentricity of the crank pin 3 in relation to the shaft element 2.

On the side opposite the crank pin 3, the transition element 4 has a pin 26, which is pressed into the hollow inside of the upper shaft section 6. Of course, the upper shaft section 6 can also be shrunk onto the pin 26, or an unrotational connection between the shaft section 6 and the pin 6 can be made in other ways.

The upper shaft section 6 is only pushed so far onto the pin 26 that a predetermined distance 27, that is, an interstice, remains between the end of the shaft section 6 and the bearing surface 14 of the transition element 4. Thus, a gap is formed, in which channels 28 formed in the pin 26 end. The channels 28 are formed by axial grooves on the surface of the pin 26. A further channel 29 is provided to improve the oil supply. This channel 29 extends into a bore 30 penetrating the transition element 4, the bore 30 ending inside the crank pin 3 and ensuring an oil transport into the inside of the crank pin 3. The oil received here can escape through an opening 31 to lubricate a connecting rod bearing with a connecting rod (not shown in detail).

The pin extends through the whole upper bearing area 10, that is, it stabilises the shaft element 2 in the area of the upper radial bearing 12. This has the advantage that the forces transmitted from a connecting rod (not shown in detail) to the crank pin 3 can be adopted by the crankshaft without causing distortion.

In the area of the bearing surface 14 of the transition element 4, the upper radial bearing 12 is chamfered, that is, it has a bevelling 32. This bevelling 32 increases the cross-sectional face of a circumferential oil channel 33, which is supplied with oil through the channels 28, 29. This improves the lubrication of the crankshaft also in the axial pressure bearing, which is formed by the bearing surface 13 and the bearing surface 14.

The two shaft sections 5, 6 and the crank pin 3 are made as deep-drawn parts, whereas the transition element 4 is preferably made as a sintered part.

FIG. 3 shows a modified embodiment of a shaft element 2. Same and corresponding parts have the same reference numbers as in FIG. 1.

It can be seen that in the overlapping area 7 the upper shaft section 6 has a diameter increase 34, through which a unilaterally open pocket 35 is formed, which is open upwards, when the crankshaft 1 is aligned vertically. Downwards it is closed by the connection between the lower shaft section 5 and the upper shaft section 6.

Further, at its lower end the lower shaft section 5 has a diameter reduction 36. This embodiment has substantial advantages, particularly with regard to the oil supply. On the inside of the shaft element 2 a shape occurs, which has an increasing diameter in the direction of the oil flow to be transported. This improves the shaping of the oil parabola occurring on rotation of the shaft element 2.

During operation breaks, in which the shaft element 2 does not rotate, the oil transported upwards during operation flows from the upper shaft element 6 downwards and is, at least partly, adopted by the pocket 35. Thus, during operation and also during operation breaks this pocket will always be filled with oil. When starting the compressor, that is, at the beginning of the rotational movement of the shaft element 2, the pocket 35 acts as oil reserves, causing a faster formation of the oil parabola and thus a faster supply of oil to the upper bearings. Until now it has only been possible to realise such a pocket 35 inside a shaft element 2 with a considerable effort.

1. Compressor crankshaft, particularly a refrigerant compressor crankshaft, with a hollow shaft element, a crank pin arranged eccentrically to the shaft element and a transition element between the shaft element and the crank pin, characterised in that the shaft element (2) has at least two shaft sections (5, 6) joined in a telescope-like manner, which engage in each other in an overlapping area (7).

2. Crankshaft according to claim 1, characterised in that a bearing area (9, 10) is located on the circumference of at least two shaft sections (5, 6).

3. Crankshaft according to claim 2, characterised in that the shaft sections (5, 6) comprising the bearing area (9, 10) are formed near the ends of the shaft element (2).

4. Crankshaft according to one of the claims 1 to 3, characterised in that a rotor (15) of a drive motor overlaps the overlapping area (7) at least partly and is unrotatably fixed on the shaft element (2).

5. Crankshaft according to one of the claims 1 to 4, characterised in that each shaft section (5, 6) is made as a deep-drawn part.

6. Crankshaft according to one of the claims 1 to 5, characterised in that a first shaft section (5) remote from the crank pin is inserted in a second shaft section (6) adjacent to the crank pin.

7. Crankshaft according to claim 6, characterised in that in the overlapping area (7), the second shaft section (6) has a diameter increase (34), which forms a unilaterally open pocket (35).

8. Crankshaft according to claim 6 or 7, characterised in that the first shaft section (5) has a tapering (17) at the end of the shaft element (2), a blade (19) being located to be adjacent to the tapering (17) in the inner chamber of the first shaft section (5).

9. Crankshaft according to one of the claims 1 to 8, characterised in that the shaft sections (5, 6) are connected with each other without the use of joining elements.

10. Crankshaft according to one of the claims 1 to 9, characterised in that the transition element (4) has a pin (26) projecting into the shaft element.

11. Crankshaft according to claim 10, characterised in that the pin (26) extends over at least the length of a bearing area (10).

12. Crankshaft according to claim 10 or 11, characterised in that the pin (26) has at least one axial channel (28, 29), which is connected with the inside of the shaft element (2).

13. Crankshaft according to claim 12, characterised in that the transition element (4) has a bearing surface (14) surrounding the pin (26), the shaft element (2) ending at a predetermined distance (27) from the bearing surface (14).

14. Crankshaft according to claim 13, characterised in that a bearing (12) located at the crank pin end of the shaft element (2) has a bevelling (32) in the area of the bearing surface (14).
